(19) United States
(12) Patent Application Publication
(10) Pub. No.: US 2026/0340980 A1
(43) Pub. Date: Oct. 29, 2026

(54) Accurately Parsing Content on a Drawing Sheet

(71) Applicant: Primepoint Labs Inc., Dover, DE (US)

(72) Inventors: Michele Covell, Woodside, CA (US); Lubomir Bourdev, Mountain View, CA (US); Hamid Palo, San Francisco, CA (US); Georgie Botev, San Mateo, CA (US)

(21) Appl. No.: 19/190,134

(22) Filed: Apr. 25, 2025

(51) Int. Cl. G06V 10/46; G06V 30/18

(52) U.S. Cl. CPC G06V 10/469; G06V 30/18

(57) ABSTRACT

In one embodiment, a method includes for each of one or more drawing sheets of a document identifying, from the drawing sheet, a set of elements corresponding to content in the drawing sheet; and grouping each of the elements in the drawing sheet into a set of one or more clusters.

### TECHNICAL FIELD

This application generally relates to accurately parsing content on a drawing sheet.

### BACKGROUND

Information is often stored electronically in the form of documents. Documents can be stored electronically in many different forms and in many different file formats. Many entities store thousands of documents or millions of documents, and some store even more.

Accurate information retrieval and content generation can require information from one portion of a document, from multiple portions of a document, or even from multiple documents. Techniques that recognize text on a page, such as optical character recognition, may be used for identifying text in a document and storing that text in a searchable format, for example so that keyword searches may be run on documents, but such techniques are not able to parse non-text content, such as drawings.

### BRIEF DESCRIPTION OF THE DRAWINGS

FIG. 1 illustrates an example of an architectural drawing sheet.

FIG. 2 illustrates an exploded view of a portion of the drawing sheet of FIG. 1.

FIG. 3 illustrates another example drawing sheet.

FIG. 4 illustrates an example parsing performed for the drawing sheet of FIG. 3.

FIG. 5 illustrates an example method for parsing the contents of a drawing sheet.

FIG. 6 illustrates an example parsing performed for the drawing sheet of FIG. 1.

FIG. 7 illustrates example output of an example process for identifying detail titles.

FIG. 8 illustrates an example computing system.

### DESCRIPTION OF EXAMPLE EMBODIMENTS

Automatically parsing the contents of a drawing sheet in a document is a difficult task for computers. A drawing sheet can contain both text and non-text content, and there is very wide variability in the location, size, orientation, and format (e.g., font, underlining, etc.) of the text and non-text content on a drawing sheet. For example, a drawing sheet may contain one or more figures, or drawings, and may include text associated with the drawing (e.g., a title for the drawing, a caption, etc.) that is different than other text that appears on the page. Similarly, non-text content such as tables contain cells and other non-text content combined with text content, and can take a variety of appearances. The appearance of text and non-text content on a drawing sheet can vary both among documents and within a document, and parsing a drawing sheet is a particularly difficult task for a computer, even using advanced tools. For example, while LLMs perform well on many tasks, they tend to perform quite poorly on spatial tasks, and simply asking an LLM (even with a well-crafted prompt) to parse the contents of a drawing sheet results in poor accuracy.

Parsing a drawing sheet becomes even more difficult when a drawing sheet contains multiple figures or other non-text content, such as multiple tables, notes, etc. For instance, drawing sheets in certain fields, such as architecture, engineering, and construction, often contain multiple figures placed very close together, which also makes parsing a drawing sheet difficult. At times, non-text content from semantically different portions of a document are placed so closely together that components of two different non-text contents (e.g., two different drawings) are closer to each other than portions of the same content are to each other. Another challenge that can occur is that some text blocks may refer to content in a particular figure, while other nearby textboxes are part of a different component (e.g., part of a table, a note, a different figure, etc.). In addition, the non-text content and associated textual content may be oriented differently on a single sheet, or page. For example, one figure may have a landscape orientation, while another figure on the same sheet may have a portrait orientation.

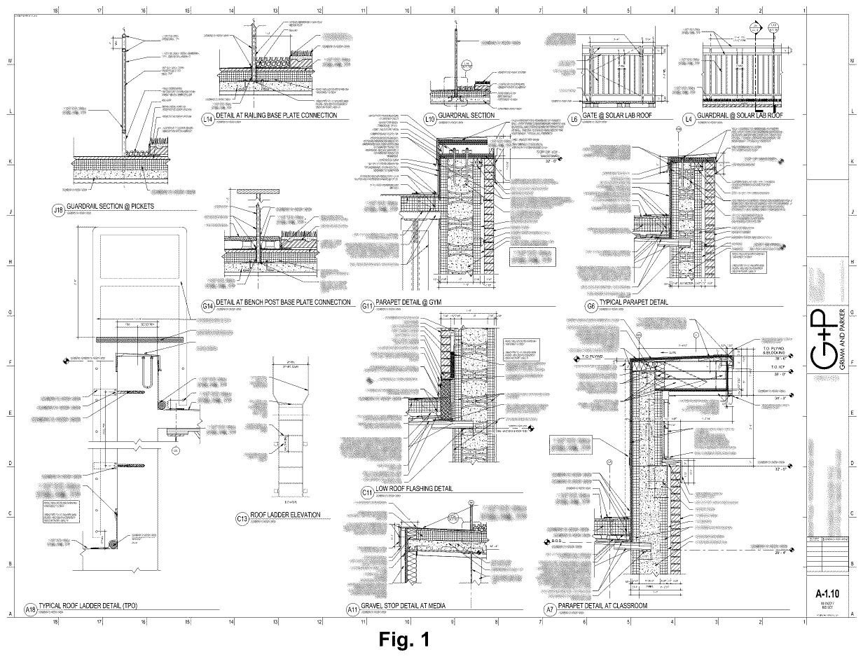

FIG. 1 illustrates an example of an architectural drawing sheet that illustrates many of these challenges. The drawing sheet of FIG. 1 contains 13 distinct drawings (such as drawing 110) of different sizes. The distance between drawings varies, as does the distance between a drawing and its corresponding title (e.g., title 105). The example drawing sheet of FIG. 1 also contains additional content such as boundaries 125, a sheet title 120 and sheet ID 115, grid lines 130, etc., none of which are standardized and all of which must be dealt with in order to accurately parse the content on the drawing sheet.

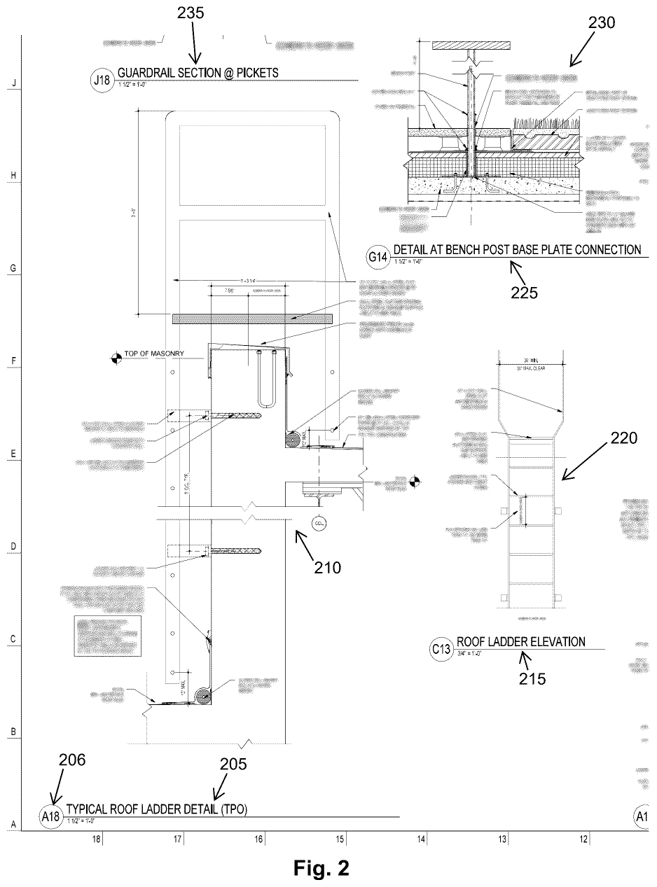

FIG. 2 illustrates an exploded view of a portion of the drawing sheet of FIG. 1, and further illustrates some of the challenges in parsing a drawing sheet. The portion in FIG. 2 includes drawing title 205 that corresponds to drawing 210, drawing title 215 that corresponds to drawing 220, drawing title 225 that corresponds to drawing 230, and drawing title 235 that corresponds to a drawing that is outside the exploded view of FIG. 2. The drawing titles in the example of FIG. 2 further include a title ID, such as title ID 206 that corresponds to drawing title 205. As illustrated in FIG. 2, portions of drawing 230 are very close to portions of drawing 210. And in fact, drawing titles 225 and 235 are closer to drawing 210 than is drawing 210's own drawing title 205.

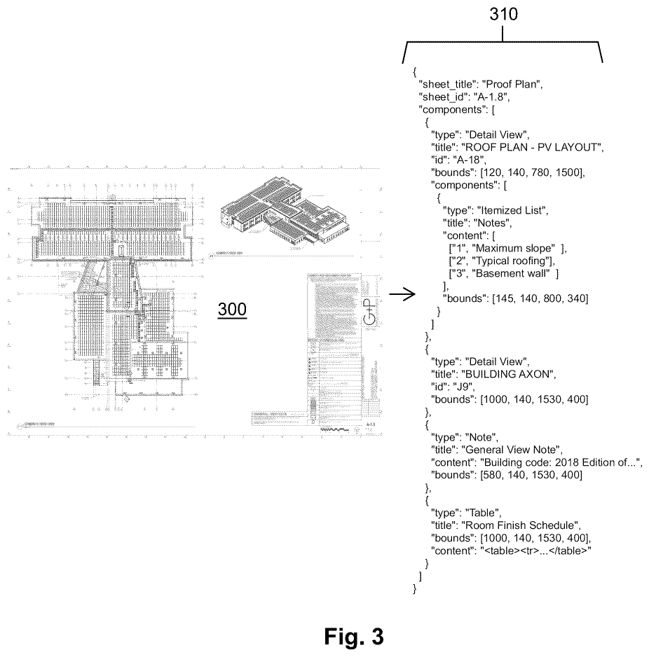

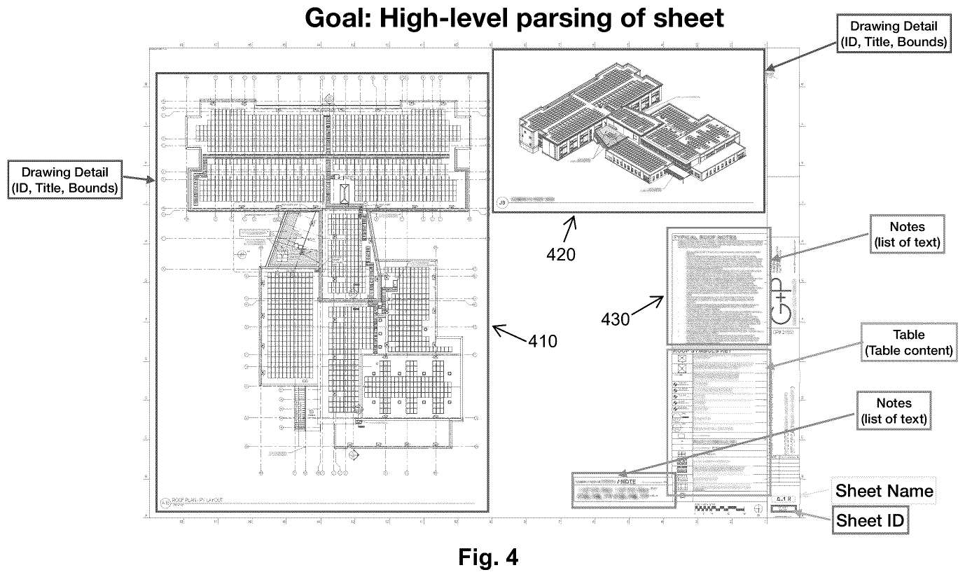

The techniques of this disclosure accurately parse drawing sheets, such as the example drawing sheet of FIG. 1. As explained below, particular embodiments parse a drawing sheet by identifying the constitute components on the sheet along with their unique location (e.g., as defined by a bounding box) on the sheet. For instance, FIG. 3 illustrates another drawing sheet 300 that contains various components, and particular embodiments of this disclosure parse the drawing sheet into a JSON format, such as JSON 310 that identifies content types, corresponding titles, corresponding IDs, a location (i.e., a “bounds” determination), and textual content for certain content types (e.g., the text with a note) for sheet 300. FIG. 4 illustrates an example parsing performed on the drawing sheet of FIG. 3 that shows the location of identified content (e.g., using bounding boxes such as box 410 and box 420, which correspond to distinct drawing details, and box 430 that corresponds to a distinct set of notes). As explained below and illustrated in FIG. 4, the bounding box that identifies the location of a particular piece of content can also include that content's related data such as the title of the content, etc.

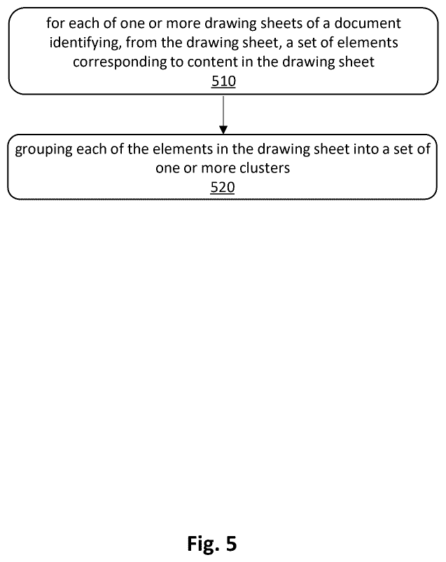

FIG. 5 illustrates an example method for parsing the contents of a drawing sheet. The method occurs on a sheet-by-sheet basis; for instance, in particular embodiments the method is run independently on each page or drawing sheet of the document. Step 510 of the example method of FIG. 1 includes identifying, from the drawing sheet, a set of elements corresponding to content in the drawing sheet.

In particular embodiments, the elements in step 510 may be cells. For example, particular embodiments may rasterize (draw) a drawing sheet into a grayscale image of relatively low resolution (e.g., 120×60 pixels). The exact resolution may be treated as a tuning parameter of the process. Then, particular embodiments may binarize the image using a threshold so that any pixel is either 1 (e.g., on) or 0 (e.g., off) depending on how much content was included in that pixel. The result is a grid that has black cells containing content and white cells that have no content.

In particular embodiments, the elements in step 510 of the example method of FIG. 1 are vector paths. Step 510 then includes identifying, from the drawing sheet, a set of vector paths corresponding to content in the drawing sheet. This step is preparation for the grouping steps that are descried below.

Vector paths are groups of one or more vector lines, curves, rectangles, and quadrilaterals (among other shapes, in particular embodiments). In particular embodiments, information about vector paths is provided as part of the document itself, e.g., as part of the structure of a PDF document that is set when that PDF is created. For instance, when a drawing program (e.g., a CAD program) exports to PDF, doing so may create blocks of content that provides drawing path groups and drawing order in the PDF document. Particular embodiments treat vector paths as mostly elemental, which can help to handle textures illustrated in a drawing.

Vector paths may also be determined in other ways. For example, vector paths may be inferred from a generalized-template matching on a rasterized image rather than directly from vectors that come from the structure of a PDF. In particular embodiments, a generalized template may include vectors identified from a scan or image of a PDF page. For instance, inferred vector paths may include one or more of: (1) line segments with inferred (e.g., from the image of a PDF page) start and end points; (2) rectangles with inferred upper-left and lower-right corner locations; (3) quadrilaterals with 4 inferred corner locations; and (4) Bezier curves with 4 inferred control-point locations, although inferred vector paths are not limited to those specific enumerated geometries.

Particular embodiment may use additional preprocessing of a drawing sheet as part of, or in addition to, a preparation process. For instance, embedded pixmaps from a PDF may be wrapped in their own vector path, so that they can be treated in the same way as vector paths. As another example, invisible elements (i.e., elements that are defined as being transparent or have a color that is identical to their background (e.g., all-white vector paths on a white page)) may be discarded. Pixmaps may be trimmed to remove all-white rows and columns to make their size as small as possible for the actual content they contain. The display region for the pixmap (e.g., as identified by its bounding box) is then changed accordingly, so that there is no shifting or stretching from this trimming.

Particular embodiments may perform page-divider identification for a drawing sheet. For instance, relatively long horizontal and vertical lines (e.g., lines that take up more than 50%, or more than 75%, etc., of the width or height of a page) are extracted and categorized as page dividers, thereby removing such lines from the set of paths that will be clustered, because including such lines in the set of vector paths can bridge the gaps between otherwise separated clusters. For instance, in the example of drawing sheet of FIG. 1, page divider classification would include the lines making up the visible border 125 of the page. As explained below, page-divider lines may be used as boundaries during a subsequent clustering process.

Particular embodiments identify and remove text from a drawing sheet as part of the preprocessing for that sheet. For example, native text may be removed or hidden from a drawing sheet, for example by covering the native text with a “white-out” box (or other box having predefined characteristics, e.g., that matches the document background) or by re-rendering the PDF while omitting the native text. An optical character recognition (OCR) or other automatic text recognition process may then be applied to the drawing sheet, and the vector paths that are covered by the recognized text are removed from the set of vector paths that will be clustered in the processes described below.

Particular embodiments may perform text-line identification as part of preprocessing a drawing sheet. Here, the goal is to remove (i.e., not cluster) lines that define text attributes, such as the underlining of titles. While an underline is a vector path, underlining text is really a formatting attribute of the text, and therefore can be excluded from the clustering process below to find distinct drawings in a sheet. Text-line or text-formatting identification may be based on heuristics particular to the type of document being parsed. For example, construction drawings often use underlining of titles, and a line may be identified if one or more of certain criteria are met, such as that the line is horizontal (relative to the page orientation), that the line at least 80% of an associated textbox width, that the line is located within a certain number of pixels (e.g., 10) of the textbox, or that the line is at least a certain amount below the center point of the textbox. Such lines, along with other vector paths related to text formatting, may be removed from the set of vector paths that will be used during the clustering processes describe below. As a result, a preprocessed drawing page has no visible text—including text that is represented in the document using vectors—making certain distance metrics described below more robust.

In particular embodiments, other content such as annotations may be identified and removed from the set of vector paths. For example, revision clouds (e.g., annotations indicating a change from the original drawings) often span multiple drawings, causing spurious connections between distinct drawings. Removing annotations can be done in various ways. For example, pattern recognition may be used to identify an annotation's (e.g., a revision cloud's) component shape. This approach can be quite accurate but computationally intensive. Another approach involves removing all Bezier curves from the grouping set of vector paths, which is very computationally inexpensive but relies on certain assumption about the annotation (e.g., that revision clouds are not drawn using many short lines at different angles).

After any preprocessing that removes vector paths from the identified set, then the remaining vector paths are used in the clustering processes described below. For example, vector paths that are not invisible nor all-white nor covered by text and have not been designated as being part of annotation and do not have a text-formatting (e.g., page divider) classification are used for clustering. As explained below, in certain embodiments page dividers are also used in clustering, but only as partitions.

Step 520 of the example method of FIG. 5 includes grouping each of the elements in the drawing sheet into a set of one or more clusters.

For example, when the elements are cells, then particular embodiments may then partition black cells into connected components. In other words, all black cells that share a boundary with each other become part of the same connected component. Each component corresponds to a particular drawing in the drawing sheet. Particular embodiments may generate a bounding box for each drawing by unioning the bounding boxes of all cells that make up a component. Alternatively, particular embodiments can use the boundaries of the cells that make up a component to create a tighter bounding box for the drawing. Particular embodiments may obtain vector paths corresponding to a drawing by going through all vector paths on the drawing sheet and selecting ones that are completely inside the cells that make up the component.

In particular embodiments, the elements are vector paths, and these vectors paths are grouped into clusters based on proximity between vector paths. The proximity between vector paths may be based on the proximity between vector paths themselves or between respective bounding boxes defining the boundaries of respective vector paths, as described more fully below.

In particular embodiments, the method of FIG. 5 includes grouping each vector path in the set of vector paths into a particular first-level cluster based on a proximity between vector paths relative to a first proximity threshold. For example, vectors paths that overlap, touch each other, or nearly touch (within a tolerance, such as a fraction of pixel) are placed into the same first-level group unless, in particular embodiments, those vector paths are separated by a page divider. In particular embodiments, proximity between vector paths is determined based on a bounding box around the vector path. For instance, a bounding box may be placed around a vector path, and this bounding box may be aligned with the axes of the drawing sheet (i.e., may be a rectangular bounding box with each side being parallel to the side of the sheet) or may be aligned with the vector path (e.g., a diagonal straight line may be defined by a rectangular bounding box having two sides parallel to the line). In some embodiments, bounding boxes need not necessarily have a rectangular shape.

Since the bounding boxes of vectors do not change in the course of clustering, the order of clustering does not impact the final result. As a result, each vector path is contained in a first-level cluster, and each first-level cluster holds at least one vector path. During grouping, first-level groups may be created and combined as the proximity among various vector paths is evaluated. This step tends to create many first-level groups, e.g., a single sheet may contain thousands of first-level groups, which is typically much, much larger than the actual number of distinct content items on the page.

In particular embodiments, the example method of FIG. 5 includes generating a bounding box around each first-level cluster and includes generating, from the first-level clusters, one or more overgrouped clusters based on a proximity among the bounding boxes of the first-level clusters. Here, the proximity may be the same distance threshold used to generate the first-level clusters of vector paths, e.g., two first-level groups may be placed into one overgrouped cluster if their bounding boxes touch, overlap, or are within a fraction of a pixel of each other. The overgrouping is an aggressive clustering process that creates tentative large groups.

For example, the text “LT” consists of a horizontal line (vector path) and vertical line (another vector path) that forms the “L” next to a horizontal and vertical line (also vector paths) forming the “T”. The first-level clustering process groups the vector paths that make up the “L” into a single cluster, since the horizontal and vertical paths are touching. Likewise, the first-level clustering process creates another, separate first-level cluster for the vector paths that make up the “T” because those paths are likewise touching. However, the first-level clustering process does not cluster the vector paths of the “L” and the “T” into a single cluster, since no vector paths within those respective characters have bounding boxes that are sufficiently close together (e.g., within fraction of a pixel of each other). While the upper vertical line of the “T” overlaps vertically with the lower vertical line of the “L”, the bounding boxes for those lines are far enough apart that they are not grouped into a single cluster. However, once a bounding box is created around the entire set of clustered vector paths making up the “L” cluster and another bounding box is formed around the entire set of clustered vector paths making up the “T” cluster, then those bounding boxes do overlap, creating a single overgrouped cluster, even though there is a clear spatial separation between those characters.

As explained below, the overgrouped clusters of vector paths are used to define the allowed connections between first-level groups during second-level grouping. In other words, if two first-level groups are not part of the same overgrouped cluster, they those two first-level groups are not allowed to join the same second-level cluster, such that the overgrouped clusters are used as a partition for the first-level clusters. And by using a relatively stringent proximity metric to overgroup first-level clusters, the techniques describe herein ensure that content that is very closely spaced on a drawing sheet will not be erroneously considered to be a single content element in the final clustering step (i.e., separate content items will strongly tend to be part of separate clusters).

In particular embodiments, the example method of FIG. 5 includes for each overgrouped cluster, forming one or more second-level clusters by re-grouping the first-level clusters in that overgrouped cluster based on a proximity between vector paths in different first-level clusters relative to a second proximity threshold, where the second proximity threshold is larger than the first proximity threshold. In this step, the first-level clusters in each overgrouped clusters are considered, and each overgrouped cluster is separately considered. Thus, first-level clusters that are part of the same overgrouped cluster may become part of the same second-level cluster, but first-level clusters that are not part of the same overgrouped cluster cannot become part of the same second-level cluster. One advantage of this approach is that it supports clustering with a larger threshold distance for forming a cluster than does first-level clustering, without grouping first-level clusters that have not previously been determined to be neighbors, thereby preventing distinct components from erroneously being identified as the same component.

The first-level clusters within a particular overgrouping are re-clustered using the bounding boxes of the vector paths within the first-level clusters (not using the bounding boxes of the first-level clusters themselves, as was used in overgrouping) to decide the distance between the first-level clusters under consideration. For instance, this step may determine whether any vector path (as defined by its bounding box) of one first-level cluster is within the second proximity threshold (e.g., 10 pixels, although this disclosure contemplates that a higher or lower threshold may be used) of the bounding box of any vector path in another first-level cluster. If so, then the two first-level clusters are grouped into the same second-level cluster. This approach recognizes and accounts for the fact that large areas of a first-level cluster's bounding box can be empty (as was the case in the bounding boxes for the “LT” example described above), and so even if the bounding boxes of two first-level clusters overlap or are very close, the bounding boxes of the constituent vector paths within those clusters may not overlap or be very close.

To determine whether first-level clusters in a particular overgrouping should be grouped into the same second-level cluster, particular embodiments use a proximity threshold that is the same as, or slightly less than, the minimum expected separation distance between distinct drawing details in the drawing sheet. This threshold may vary based on the use case (e.g., architectural documents may have a relatively small threshold), and may be treated as a hyperparameter than can be set manually or automatically. The proximity threshold here is greater than that used in first-level clustering, resulting in second-level clusters that can contain more vector paths than the first-level clusters, even though the same bounding boxes are being compared. This approach ensures well-defined boundaries between second-level groups, and because the grouping hierarchy structure is kept, this approach allows the second-level groups to be broken apart (if needed) without falling all the way down to separate paths.

In particular embodiments, there may be an “island” of vector paths that is in the middle of, but relatively far from (e.g., separated by empty space from), a grouped set of vector paths that largely or entirely surrounds the island. When the vector paths in an island are not close enough to the neighbors to be absorbed in the second-level grouping, then in particular embodiment, after creating second-level clusters such small groups are clustered with the second-level cluster that covers or surrounds them.

In particular embodiments of the process described above, paths may be placed in to second-level clusters without knowing where the detail titles are (e.g., because the process described below for determining detail titles is run in parallel with the clustering process). In such embodiments, some second-level groups may encompass the detail titles, due (for example) to crowding between drawing or to poor removal of extraneous marks (e.g., annotations). When this happens assignment of that second-level group to a title typically is infeasible and the group would not be assigned to any detail title. When this happens with a large group that actually includes within it a full detail drawing, then the assignment process may fail to find the correct pairing, not just for that drawing, but for neighboring ones as well. Instead of having many large infeasible groups, after identifying the detail title positions but before doing any of the pairing between details and groups, all of the groups may be checked to see if they are infeasible. If a second-level group is infeasible and if that is because it covers (or mostly covers) one or more detail titles, the second-level group can be broken up. For instance, one technique is simply to break the infeasible cluster into its component first-level groups. An alternative technique includes finding the division between first-level groups in that second-level group which does not cover the detail title or limits that intersection to the smallest number of final groups.

In particular embodiments, manual review may be performed on the identification of drawing details. To make this review process more efficient and interactive, particular embodiments perform clustering before obtaining the detail titles and then cache the clustering results. Particular embodiment may also hypothesize which text might be titles. For example, nearly all textboxes above a certain font size which have an associated title line wind up being titles, and titles on a single page typically all have the same font size and family. Using clues like this, particular embodiments may precompute the assignment of groups to hypothesized detail titles, and cache those results as well. If the hypothesized titles do not wind up being the same as the final titles (provided either by the top-down process or by manual review), then separately caching the first-and second-level groupings still make the final step of re-clustering after manual review more efficient.

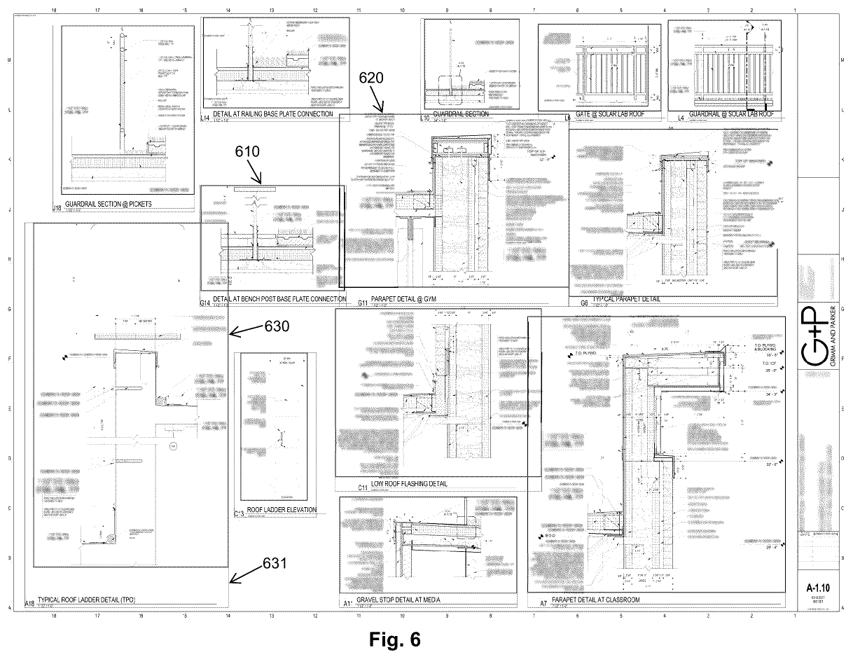

FIG. 6 illustrates an example parsing performed for the drawing sheet of FIG. 1. As illustrated in FIG. 6, each drawing detail in the drawing sheet has been identified by a bounding box. Notably, given the closeness between certain drawing details, some bounding boxes for particular drawings overlap with each other (e.g., bounding box 610 overlaps with box 620 and box 630), yet the techniques described herein accurately are able to accurately parse each drawing.

To obtain the locations of detail titles (i.e., titles for non-text content on a sheet), particular embodiments may pass one or more seed drawing sheets from a document to an LLM and, using a prompt, request that the LLM output for each sheet (1) a sheet ID and (2) a sheet name and (3) a content type for each type of content on the drawing sheet, along with corresponding text for that content such as content ID and title. The prompt may require that the sheet ID and the sheet name be identified verbatim from text on the drawing sheet. The content type is specified from a set of available content labels (e.g., drawing, table, notes, etc.), which may be described in the prompt and/or may be accompanied in the prompt by examples.

Particular embodiments may submit a request to an LLM to output items (1)-(3) together or separately, e.g., using separate prompts. For instance, a sheet may be cropped (based on document conventions) to include a portion of the sheet that typically contains the sheet ID and name, and this cropped portion may be passed to the LLM along with a corresponding prompt, while the full sheet may be passed to the LLM along with a corresponding prompt to identify the content types on the sheet. The LLM then outputs the requested information, for example in a JSON format. A prompt may instruct the LLM to retain text formatting (e.g., preserve capitalization) and may describe the format for the output. In particular embodiments, an LLM may be permitted to output “none” or similar output when some data is not found, e.g., when no title ID is identified for a particular type of identified content.

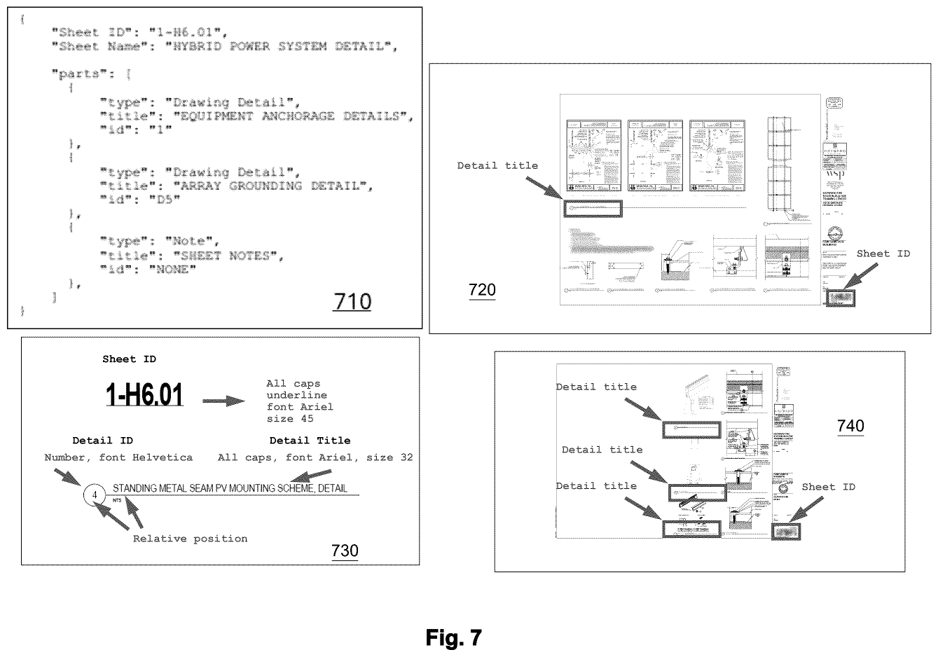

FIG. 7 illustrates example output of an example process for identifying text types in a document. Step 710 illustrates an output of an LLM based on the prompts and at least a portion of a seed sheet, as described above. Separately, the text from each seed drawing sheet is extracted, along with that text's style such as the font type, font size, location on the page, etc. Native text is extracted as is, while non-native text (e.g., text represented as an image) may not be correct after extraction (e.g., using OCR techniques). In particular embodiments, then, non-native extracted text may undergo additional processing to ensure accuracy. For example, the vertical coordinate of each word may be determined, and words that are on the same line (i.e., share the same vertical coordinate, to a certain tolerance) are grouped together to form lines of text. A similar process may be used with horizontal coordinates to combine lines of text into paragraphs. In particular embodiment, this text extraction may occur as part of a preprocessing step for clustering, described above.

Then, the extracted text (which includes native text) and the text identified by the LLM are matched together, if possible. In particular embodiments, matching strings between those two types of output may use the Levenshtein distance metric to account for imperfections (e.g., misspellings, formatting changes, etc.) in one or both outputs. In particular embodiments, matching may be tuned based on the type of drawing sheet being parsed; for example, in use cases where a sheet ID typically appears immediately below the sheet title, then the extracted text may be limited to areas immediately below the sheet title when matching with output from the LLM.

In particular embodiment, output that is not matched (e.g., appears in only LLM output or only in extracted output) or output that has multiple matches is discarded, in order to prioritize accuracy in matched content. Output 720 illustrates an example of matched content, in which the extracted text of a detail title is matched with text categorized by the LLM as a detail title. The LLM's output provides the categorization for this text (i.e., that it is a detail title), while the extracted output provides the text style for the text (e.g., its font size, font type, location on the sheet as determined by its bounding box in the example of FIG. 7). Output 720 also illustrates matching of a sheet ID text type.

Once text output is matched, then the style of the matched text as determined from the extracted text is associated with the text-type label (e.g., sheet ID, sheet title, title ID for a table, title for a drawing, etc.) as determined by the LLM. In other words, once a match between extracted text and the LLM output is obtained, the style (as determined by the text extraction process) and the type or purpose of the text (e.g., that the text is a title for a table, or is a sheet ID, etc.) are linked together. For instance, a drawing title in a particular document may use all caps formatting, a particular type and size of font, have an underline beneath the text, etc., and these styles attributes may then be associated with drawing titles. Likewise, title IDs may have only numeric or alphanumeric characters, may be relatively short (e.g., three or fewer characters), may be embedded in a geometric object such as a circle, etc., and these style attributes may be associated with title IDs. Output 730 in the example of FIG. 7 illustrates example style attributes extracted from the matched text shown in output 720.

In particular embodiments, multiple different style types may be associated with a particular text type based on the results of the matching process. For example, if a sheet ID is associated with a particular style and another sheet ID in the same document is matched with text having a different style, then both style types may be associated with the sheet ID type.

Once styles are associated with text types, then these styles may be used to automatically locate and parse (e.g., using a bounding box) the corresponding text types on other drawing sheets in the document. For instance, text on other drawing sheets may be identified as a drawing title, sheet ID, etc. when that text contains a style match to the drawing-title type. To do so, particular embodiments extract text from the other drawing sheets and determine the extracted text's style. Then, the extracted text's style is matched to the existing styles types already associated with the text-type labels (e.g., sheet ID, detail title or drawing title, title ID, etc.). In particular embodiments, automatically identified text types can be manually reviewed and adjusted to ensure accuracy. Output 740 in the example of FIG. 7 illustrates an example of identifying text types on a drawing sheet based on style match.

After determining the title locations on a drawing sheet from the process described above, then the second-level clusters are assigned to particular titles, for example using an anisotropic separation measure that takes into account the conventions that are used in the particular drawing sheet at issue. For instance, in architectural drawings, the body of drawings rarely extend below the title, so second-level clusters that extend below a detail title (e.g., as determined by that cluster's bounding box) measure as being at an infinite distance from the title. As another example, the body of drawings tend to extend only slightly (if at all) to the left of a drawing identifier, so clusters that are too far to the left of a drawing identifier measure as being at an infinite distance from the title. As another example, in architectural drawings a drawing typically will not intersect with page dividers, other than (perhaps) the drawing's own title line, if such title line is long enough to be identified as a page divider. Particular embodiments of vector-path clustering use page-divider lines as partitions but the dividers also impact associating titles with drawing bodies. For title-cluster pairings in which the pairing would intersect with more page dividers than drawing's own title line, the distance metric is set to infinity. Continuing this example, for the remaining pairings, the distance metric is a function of how closely associated they are. For instance, one example distance metric is the area of the covering box minus the original areas of the separate parts.

Particular embodiments may use a similar approach for grouping text with table and note titles, but may use a different separation measure based on the different conventions of tables and notes.

To make the title and second-level cluster assignments, particular embodiments may use a cost matrix (e.g., where the rows specify drawing titles and the columns specify second-level clusters). Infeasible groups, such as those covering multiple titles or separated by dividers as discussed above, are removed. A Kuhn-Munkres algorithm may then be used to optimally assign groups to titles for as many pairs as possible. As a result of this process, every identified title will have an associated second-level group. However, there may be many second-level clusters that are not assigned to any title, as the procedure described above can generate many second-level groups.

Remaining feasible but unassigned groups are assigned via a greedy approach, in particular embodiments. For instance, a distance matrix may be used to determine how close (based on an anisotropic distance measure) each unassigned second-level cluster is to an assigned title grouping, where the assigned title grouping includes the title and any associated second-level group (i.e., the assigned title grouping will grow as more second-level groups are assigned to that particular title grouping). This disclosure contemplates that title and cluster assignments may be made using other assignment techniques.

In particular embodiments, the clustering techniques described herein may fail, for instance when groups are deemed infeasible. Since the regions in which that happens is well defined (the spatial extent of the groups that are not assigned is known, as well as the identities and locations of the titles that are orphaned), particular embodiments may use other grouping approaches in these regions. For example, particular embodiments may use a Voronoi-based approach on the regions of the drawing sheet for which the clustering techniques fail. These regions may be rasterized and then passed to the Voronoi process, which leverages geometric proximity among graphical elements (such as vectors or pixel clusters) to systematically partition the drawing area into distinct regions, especially when other methods fail.

For example, the Voronoi process uses black pixel coordinates extracted from the processed binary image to generate a Voronoi diagram. Each Voronoi cell corresponds to the region closest to a specific black pixel. Then, a boundary adjustment is performed in which the Voronoi cell edges (ridges) that extend beyond the image boundaries are carefully clipped to terminate precisely at the drawing's edges, ensuring valid segmentation boundaries.

To identify optimal cuts, the connectivity graph is partitioned into connected components—groups of vertices (ridge intersections) linked by valid edges. Components that span across multiple image boundaries (e.g., from top to bottom or left to right) are identified as candidates for significant segmentation boundaries. A shortest-path analysis is then performed, in which for each candidate connected component, potential segmentation paths are evaluated by (1) identifying boundary vertices (points on the image edges) (2) calculating the shortest paths between vertices located on opposite boundaries and (3) selecting the component with the longest shortest-path between boundary vertices, as this typically indicates the most significant natural segmentation boundary within the drawing region being parsed.

In other words, particular embodiments attempt to find the longest shortest path from valid connected components of ridge edges linking ridge vertices. In particular embodiments, the set of considerations is limited to natural divides first. For example, particular embodiments consider cases where there is a path connecting the left and right sides of an image boundary or the top and bottom sides of an image boundary. If both exist, then the shortest is picked. During a particular iteration (discussed below), only if either of the two previous cases aren't satisfied, do embodiments then consider connections between separate image boundaries (like left and top, left and bottom, right and top, and right and bottom). In particular embodiments, Euclidean distance may be used as the distance metric for assigning a weight to each of the ridge edges, but this disclosure contemplates that other distance metrics may be used.

After determining the optimal segmentation boundary, the drawing is split along this boundary into two or more separate regions. The Voronoi segmentation process is then applied recursively to each newly formed sub-region, continuing this iterative segmentation until further segmentation ceases, for example based on when the remaining orphaned drawing titles can each be associated with a distinct segmented region. In particular embodiments, certain recursive calls may end up returning components that aren't necessarily useful (like a small collection of black pixels, or a part of some drawing detail in some failure cases), and one or more additional filtering heuristics may be used to disregard those components.

After title-cluster assignments are finalized, then a bounding box is created around the second-level clusters that are assigned a drawing title, where the bounding box includes the vector paths of the second-level cluster and assigned title. For instance, the example of FIG. 6 illustrates bounding boxes that include second-level clusters and their assigned title (e.g., as illustrated by bounding box 631). A bounding box may be expanded to include nearby text if that text is associated with at least one vector path that is inside the bounding box. Each textbox is assigned to at most one drawing (as defined by the created bounding boxes), based on proximity.

In an effort to move as much computation to before any manual review of detail titles, particular embodiment may move the association of text (which is described above as happening after obtaining titles) to earlier in the process. To do this, particular embodiments take the second-level groups and associate them with nearly touching text, using the same criteria as described above, e.g., if the text is close to one or more of the vector paths within a second-level group (and not closer to paths in any other second-level groups), then the text is associated with that second-level group. To accommodate the possibility that a second level group will be broken up, this association may be down to the level of the first level group. However, the associated text does not change the bounding box of any connected group when clustering or title-group assignment is being done.

In particular embodiments, content in drawings on a drawing sheet can be associated with text in other content on the drawing sheet, such as text in a note or a table, etc. For instance, annotations on drawings may be identified along with text from the annotations, and this text may be matched from text in other content on the drawing sheet. In particular embodiments, matching content from drawings with text in other content may be based on the number of items present in each. For instance, if an annotation numerically calls out 8 features (e.g., using “1”,” “2”, and so on as identifiers in a drawing), then a list on that drawing sheet that likewise contains 8 enumerated items may be matched with that drawing. In addition or the alternative, matching may be semantically based. For example, a drawing and a list of notes may be provided to an LLM along with a prompt requesting the LLM to output whether the listed items semantically match what is illustrated in the drawing.

In particular embodiments, identified content on a drawing sheet may be annotated to obtain additional information about the content. For example, once a drawing or a table is identified and isolated, then that content (e.g., the content as cropped according to its bounding box) may be provided to an LLM along with a prompt instructing the LLM to describe the content (e.g., describe what the drawing or table is about, provide metadata about the drawing or table (e.g., its dimensions, etc.), and so on). These annotations may be stored in connection with the drawing-sheet content, for instance by storing the identified content elements and the annotations in a knowledge graph to facilitate a retrieval task (such as a retrieval-augmented generation task) and/or to surface to a user upon request.

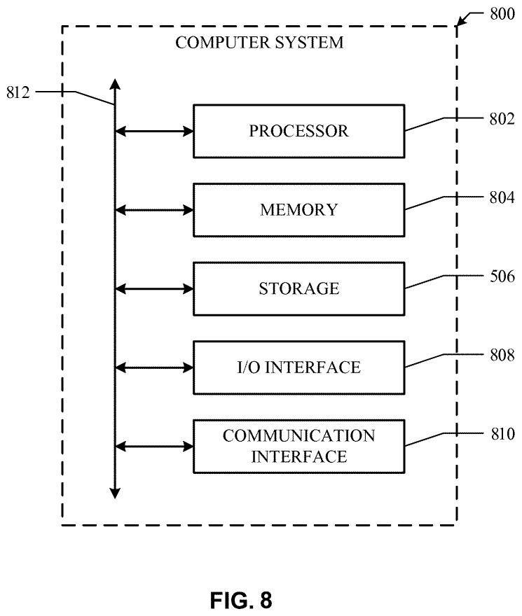

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising, for each of one or more drawing sheets of a document:
identifying, from the drawing sheet, a set of elements corresponding to content in the drawing sheet; and
grouping each of the elements in the drawing sheet into a set of one or more clusters.

2. The method of claim 1, wherein each element comprises a vector path.

3. The method of claim 2, wherein grouping each vector path in the drawing sheet into the set of one or more clusters comprises grouping each vector path in the drawing sheet into a set of one or more clusters based on a proximity between vector paths.

4. The method of claim 3, further comprising
grouping each vector path in the set of vector paths into a particular first-level cluster based on proximity between vector paths relative to a first proximity threshold;
generating a bounding box around each first-level cluster;
generating, from the first-level clusters, one or more overgrouped clusters based on a proximity among the bounding boxes of the first-level clusters; and
for each overgrouped cluster, forming one or more second-level clusters by re-grouping the first-level clusters in that overgrouped cluster based on a proximity between vector paths in different first-level clusters relative to a second proximity threshold, wherein the second proximity threshold is larger than the first proximity threshold.

5. The method of claim 4, wherein identifying the set of vector paths corresponding to content in the drawing sheet further comprising removing, from the set of vector paths, vector paths corresponding to invisible content on the drawing sheet.

6. The method of claim 4, wherein identifying the set of vector paths corresponding to content in the drawing sheet further comprising removing, from the set of vector paths, vector paths corresponding to a page divider on the drawing sheet.

7. The method of claim 4, wherein identifying the set of vector paths corresponding to content in the drawing sheet further comprising removing text on the drawing sheet.

8. The method of claim 4, wherein the first proximity threshold comprises a fraction of a pixel.

9. The method of claim 4, wherein the second proximity threshold comprises a plurality of pixels.

10. The method of claim 4, wherein grouping each vector path in the set of vector paths into a particular first-level cluster based on proximity between vector paths relative to a first proximity threshold comprises:
determining, for each vector path, a bounding box around that vector path; and
determining the proximity between vector paths based on a proximity between the respective bounding boxes of those respective vector paths.

11. The method of claim 4, wherein the proximity among the bounding boxes of the first-level clusters is determined relative to the first proximity threshold.

12. The method of claim 4, wherein re-grouping the first-level clusters in an overgrouped cluster based on a proximity between vector paths in different first-level clusters comprises:
determining, for each vector path, a bounding box around that vector path; and
determining the proximity between vector paths based on a proximity between the respective bounding boxes of those respective vector paths.

13. The method of claim 4, further comprising:
providing at least a portion of a seed drawing sheet from the document to an LLM along with one or more prompts requesting the LLM to categorize text on the seed drawing sheet using a set of predetermined labels;
separately extracting, from at least the portion of the seed drawing sheet, text and one or more corresponding text styles;
matching categorized text output by the LLM with the separately extracted text; and
determining, based on each match, a text style for one of the predetermined labels.

14. The method of claim 13, further comprising:
extracting text from the drawing sheet of claim 1;
determining a style for the text extracted from the drawing sheet of claim 1;
matching the determined style of the text with a text style of a predetermined label; and
determining, based on the style match, a text type of the text extracted from the drawing sheet of claim 1.

15. The method of claim 14, wherein the text type comprises a drawing title.

16. The method of claim 15, further comprising assigning each identified drawing title on the drawing sheet of claim 1 to one or more second-level clusters on that drawing sheet.

17. The method of claim 16, wherein each assignment is made based on an anisotropic separation measure between the respective drawing title and respective second-level clusters.

18. The method of claim 16, further comprising determining, for each identified drawing title and assigned one or more second-level clusters, a bounding box defining the location of that drawing title and assigned one or more second-level clusters on the drawing sheet.

19. The method of claim 4, further comprising:
identifying one or more second-level clusters for subsequent parsing; and
parsing the content represented by the identified one or more second-level clusters using a Voronoi process.

20. The method of claim 4, wherein identifying, from the drawing sheet, a set of vector paths corresponding to content in the drawing sheet comprises inferring, from an image of drawing sheet, the set of vector paths.

21. The method of claim 1, wherein:
each element comprises a grid cell of a grid obtained by rasterizing vector paths in the drawing sheet;
grouping each of the elements in the drawing sheet into a set of one or more clusters comprises extracting connected components of occupied grid cells; and
the method further comprises assigning, for each group, a vector path in the drawing sheet that is contained within one or more grid cells that make up a connected component.

22. A system comprising:
one or more non-transitory computer readable storage media storing instructions; and one or more processors coupled to the one or more non-transitory computer readable storage media and operable to execute the instructions to:
identify, from each drawing sheet of one or more drawing sheets of a document, a set of elements corresponding to content in the drawing sheet; and
group each of the elements in the drawing sheet into a set of one or more clusters.

23. One or more non-transitory computer readable storage media storing instructions that are operable when executed by one or more processors to:
identify, from each drawing sheet of one or more drawing sheets of a document, a set of elements corresponding to content in the drawing sheet; and
group each of the elements in the drawing sheet into a set of one or more clusters.
